(19) United States
(12) Patent Application Publication
(10) Pub. No.: US 2006/0263566 A1
(43) Pub. Date: Nov. 23, 2006

(54) Method for bonding facing to insulation

(75) Inventors: John O. Ruid, Schwenksville, PA (US); Kenneth D. Knapp, Norristown, PA (US)

Correspondence Address: DUANE MORRIS, LLP;IP DEPARTMENT, 30 SOUTH 17TH STREET, PHILADELPHIA, PA, 19103-4196, US

(73) Assignee: CertainTeed Corporation

(21) Appl. No.: 11/130,482

(22) Filed: May 17, 2005

(51) Int. Cl. B32B 3/10

(52) U.S. Cl. 428/43; 428/137; 156/291

(57) ABSTRACT

A method and configuration are provided for joining a facing having periodic rows of perforations to insulation. Adhesive is applied to the perforated facing in a periodic pattern. The facing is joined to the insulation. The periodic pattern is offset from the rows of perforations, or the period of the pattern is different from the period of the rows of perforations, so that at least some of the perforations do not coincide with any of the pattern of adhesive.

### FIELD OF THE INVENTION

The present invention relates to building insulation products generally, and more specifically to methods for bonding a facing to insulation.

### BACKGROUND

In areas where humidity is high, there is a great deal of concern regarding entrapment of water vapor in building insulation. Insulation used in high humidity areas may be prone to condensation, which can lead to rotting of wood sills, mold, and bacterial growth. The problem of moisture entrapment within insulation is especially a concern on basement walls, as Basement wall insulation can be located in a humid environment. This insulation is often faced with foil-scrim-kraft (FSK) or polypropylene-scrim-kraft (PSK), which reduces water vapor transmission. When FSK/PSK faced products were first supplied to the marketplace, this facing was considered for practical purposes to be non-permeable. More recently, this facing has been supplied with micro-perforations, which suggests it to be permeable to allow for the transmission of moisture. The vapor condensation problem can be reduced by using these perforated facings, but the adhesive used to laminate the facing to the insulation can cover the perforations and greatly limit permeability.

U.S. Pat. No. 4,726,985 discloses an insulation product having a perforated foil-kraft laminate facing. The facing is laminated to the fiber glass insulation layer using adhesive. The perforations are sized at 0.040 to 0.060 inch in diameter to ensure sufficient size to allow water vapor to escape, to prevent the laminate from acting as a vapor retarder. The adhesive is applied in a plurality of stripes or beads to reduce adhesive costs. However, U.S. Pat. No. 4,762,985 does not disclose or suggest a method of improving this configuration to enhance porosity.—, thus increasing the level of permeability.

### SUMMARY

In some embodiments, a method for joining a perforated facing having periodic rows of perforations to insulation includes applying adhesive to the perforated facing in a periodic pattern of stripes. The facing is joined to the insulation, so that a first distance between each pair of adjacent rows of perforations in the facing is different from a second distance between each pair of adjacent stripes of adhesive, and at least some of the rows of perforations do not coincide with any of the stripes of adhesive.

In other embodiments, a method for joining a facing having a plurality of periodic rows of perforations to insulation comprises the steps of: applying adhesive to the perforated facing in a periodic pattern of adhesive, and joining the facing to the insulation, wherein the periodic pattern is offset from the rows of perforations, so that substantially all of the perforations do not coincide with any of the patterns of adhesive.

### BRIEF DESCRIPTION OF THE DRAWINGS

FIG. 1 shows a laminate including insulation material and a facing.

FIG. 2 is a detailed isometric view of a variation of the laminate of FIG. 1, showing a first configuration of adhesive stripes.

FIG. 3 is a detailed isometric view of a variation of the laminate of FIG. 1, showing a second configuration of adhesive stripes.

FIG. 4 is a detailed isometric view of a variation of the laminate of FIG. 1, showing a third configuration of adhesive stripes.

FIG. 5 is a schematic diagram showing apparatus for applying the facing to the insulation of FIG. 1.

FIG. 6 is a detailed schematic diagram of the grooved roller of FIG. 5.

FIG. 7 is a diagram of an alternative grooved roller.

FIG. 8 is an isometric view of a laminate having a fourth configuration of adhesive patterns.

FIG. 9 is an isometric view of a laminate having a fifth configuration of adhesive patterns.

FIG. 10 is an isometric view of a laminate having a sixth configuration of adhesive patterns.

FIG. 11 is a plan view of a laminate having another adhesive pattern.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

U.S. Pat. No. 4,726,985 is incorporated by reference in its entirety, as though fully set forth herein.

As used herein, the term “stripe” can refer to either: (1) a continuous line segment, or (2) a line segment having a finite number of gaps, comprising a collinear set of dabs, dots, dashes and/or smaller line segments. In some embodiments, the stripes all have a single, constant width. In other embodiments, the width of the stripes varies, either within or between stripes.

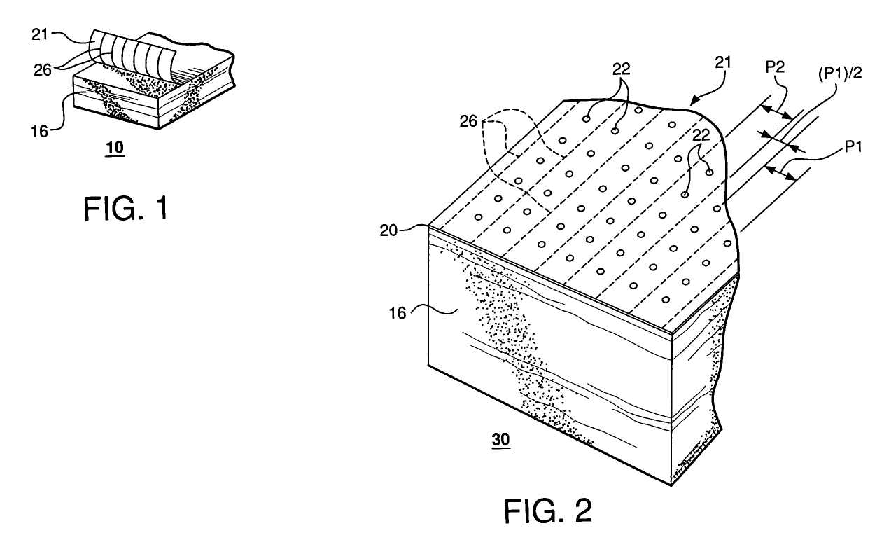

FIG. 1 shows an exemplary insulation configuration 10 in accordance with an embodiment of the present invention. In the method of FIG. 1, a facing 21 is adhered to a batt or blanket of insulation 16 using a plurality of patterns comprising, for example, stripes of adhesive 26. The facing 21 is a perforated facing having periodic rows of perforations 22 (FIG. 2). The adhesive 26 is applied to the perforated facing 21 in a periodic pattern of stripes 26. The periodic stripes 26 are offset from the rows of perforations 22, or the period of the stripes is different from the period of the rows of perforations, so that at least some of the rows of perforations do not coincide with any of the stripes of adhesive.

In one embodiment, the insulation 16 comprises glass or mineral wool having a density in the range of about 0.4 to about 1.5 pcf and an insulating value in the range of R-8 to R-38. The facing 21 may comprise foil-scrim-kraft (FSK) or polypropylene-scrim-kraft (PSK), with perforations generally in the range of about 0.040 to about 0.060 inch in diameter spaced about ¾ inch apart. The adhesive 26 may be a water based adhesive, and may be based on a material such as ethylene vinyl acetate or polyvinyl acetate which has been made fire retardant by the addition of dry filler or liquid flame suppressant additives. The method and configuration described herein may also be used with other insulation materials, other types of perforated facings having various types of perforations and spacings, and other types of adhesives and adhesive application methods.

FIGS. 2-4 show three variations of the configuration of FIG. 1. Like reference numerals denote like items in each drawing.

FIG. 2 shows an embodiment of a blanket or batt 30 in which a first distance P1 between each pair of adjacent rows of perforations 22 in the facing 21 is substantially the same as a second distance P2 between each pair of adjacent stripes of adhesive 26, and the stripes of adhesive 26 are offset from the rows of perforations 22. In this configuration, none of the perforations 22 are covered by the stripes of adhesive 26. Although FIG. 2 shows each stripe 26 of adhesive offset by about one half of the distance P1 from an adjacent row of perforations 22, another offset may be used. By offsetting the adhesive by 0.5*P1 from the rows of perforations, the likelihood of accidental blockage of the perforations by adhesive (due to tolerance in the placement of the facing 21 on the insulation 16, the width of the adhesive, or spreading out of the adhesive) is reduced. Therefore, in this embodiment, an offset of 0.5*P1 is preferred if the adhesive pattern is wide, of if the adhesive is of a type that is known to spread out substantially. In FIG. 2, the width of the adhesive pattern is less than the spacing between rows of perforations. It will be understood that this technique may also be applied in configuration where a small number of rows (e.g., the two rows at the lateral edges of the lane or batt of insulation) are intentionally blocked, for example, in order to have extra adhesive at certain areas where delamination is likely to occur. For the lane/batt as a whole, the rows of perforations still substantially do not coincide with any of the pattern of adhesive.

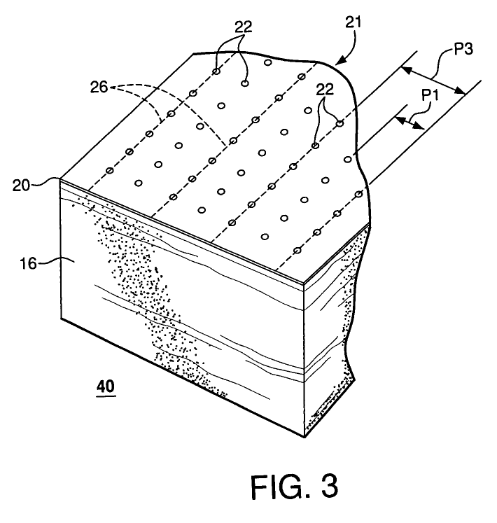

FIG. 3 shows a variation of the configuration of FIG. 1, in which a first distance P1 between each pair of adjacent rows of perforations 22 in the facing 21 is different from a second distance P3 between each pair of adjacent stripes of adhesive 26. In FIG. 3, the second distance P3 between successive periodic stripes of adhesive 26 is greater than the first distance P1 between successive periodic rows of perforations 22. So long as the second distance P3 between successive periodic stripes of adhesive 26 is greater than the first distance P1 between successive periodic rows of perforations 22, at least some of the rows of perforations 22 do not coincide with stripes of adhesive 26, even though one or more stripes of adhesive 26 may be located on or under one or more of the rows of perforations 22.

In some embodiments, the second distance P3 is a multiple of the first distance. This ensures that, at most, a predetermined fraction of the perforations 22 are blocked by stripes of adhesive 26. For example, in the embodiment of FIG. 3, the second distance P3 is twice the first distance P1, so that no more than approximately half of the rows of perforations 22 (rounded up to the next integer) are blocked by stripes of adhesive 26. For any given ratio of (P3/P1), at most approximately (P1/P3) times the number of rows of perforations (rounded up to the next integer) are blocked. In the embodiment of FIG. 3, because the spacing between adhesive patterns is twice the spacing between rows of perforations, it is practical to use a wider adhesive pattern than in the embodiment of FIG. 2. Any adhesive pattern having a width less than about twice the spacing between rows of perforations would still leave alternating rows of perforations unblocked by adhesive.

In the embodiment of FIG. 3, at least one stripe 26 of adhesive is located on or under one of the rows of perforations 22. However, if the ratio of (P3/P1) is an integer, then all of the stripes of adhesive 26 can optionally be offset from the rows of perforations (in the manner shown in FIG. 2), so that none (or substantially none) of the rows of perforations are blocked. As described above, any offset can be used, but an offset of 0.5*P1 minimizes the likelihood of adhesive 26 blocking the perforations 22 in the event of a misalignment between the facing 21 and the insulation 16, or spreading of the adhesive.

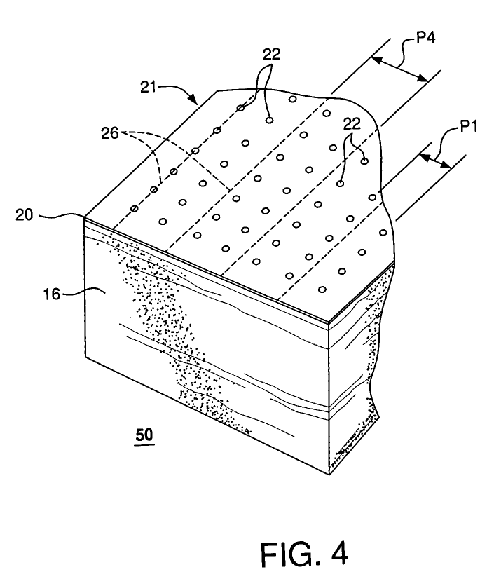

FIG. 4 shows another variation in which the a first distance P1 between each pair of adjacent rows of perforations 22 in the facing 21 is different from a second distance P4 between each pair of adjacent stripes of adhesive 26. In FIG. 4, the distance P4 is not an even multiple of P1. For example, in FIG. 4, the ratio of P4:P1 is about 7:4. Only approximately every 7^{th} row of perforations is blocked by a stripe of adhesive. By using a non-integer ratio of P4:P1, it is possible for the number of stripes of adhesive 26 to more closely approach the number of rows of perforations 22 with a relatively low percentage of the rows of perforations being blocked. By way of comparison, the distance between the stripes of adhesive 26 in FIG. 4 is close to that of FIG. 3, but the fraction of rows of perforations that coincide with stripes of adhesive is much lower with the non-integer ratio of P4:P1 shown in FIG. 4 than the integer ratio P3:P1 shown in FIG. 3. Although FIG. 4 has a much lower fraction of the perforations blocked than FIG. 3, the density of the stripes of adhesive is actually greater in FIG. 4, so that the integrity of bond between the insulation 16 and the facing 21 is as good or better in the configuration of FIG. 4. Thus, it is advantageous to have periodic stripes of adhesive 26 that are spaced apart by a distance P4 that is not an integer multiple of the spacing P1 between adjacent rows of perforations 22. Because some of the patterns of adhesive can be close to a row of perforations, a relatively narrow adhesive pattern (using adhesive of a type that does not spread out very much) is preferred for this embodiment.

Although FIG. 4 shows an example in which P4/P1 is a non-integer number greater than one, greater density of adhesive stripes may be achieved by selecting P4 such that the ratio P4/P1 is less than one. In this case, to prevent blockage of a large fraction of the rows of perforations 22 with the adhesive, P4 should be selected so that the smallest integer multiple of P4/P1 is substantially greater than 1.

For example, P4 may be greater than 0.5 and closer to P1. If P4/P1=0.6, then the smallest integer multiple of P4/P1 is 3, and at most, every third row of perforations can be blocked. If P4/P1=0.7, then the smallest integer multiple of P4/P1 is 7, and at most every seventh row of perforations can be blocked. If P4/P1=0.8, then the smallest integer multiple of P4/P1 is 4, and at most every fourth row of perforations can be blocked.

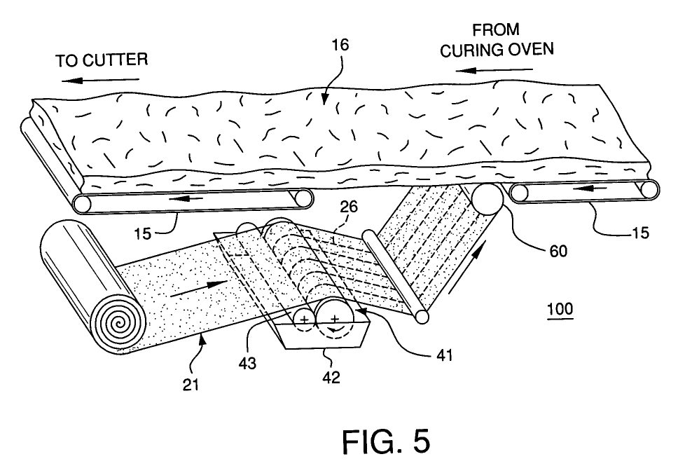

FIG. 5 is a diagram showing a process and laminating apparatus 100 for applying the facing 21 to the insulation batts 10, 30, 40 and 50 shown in FIGS. 1-4.

In FIG. 5, the adhesive 26 is applied to the facing 21, and the facing 21 is attached to the insulation 16 on the insulation production conveyor 15, before the insulation material is cut into individual pieces. Initially, the insulation 16 is a continuous lane of mineral fiber insulation that is many times longer than the final cut product. The continuous lane of mineral fiber insulation 16 is constructed from a low density fibrous glass or mineral wool. The glass fibers may be formed by a rotary or other type process, in which glass from a furnace (not shown) enters rotary spinners (not shown) or some other configuration of processing equipment, where the glass is formed into long fibers in a loose glass wool, and the fibers are coated with a resin binder, such as phenol urea formaldehyde (PUFA), for example in a spraying process. The fibers are loaded onto a conveyor and delivered to a curing oven (not shown). From the curing oven (not shown), the conveyor 15 carries the insulation 16 to the laminating station 100 shown in FIG. 5

In the laminating station 100, the facing 21 is fed in, and the adhesive 26 can be applied to the facing 21 with a grooved roller 41, one of a number of means to apply an adhesive for purposes of laminating the facing to the insulation. The facing 21 is passed over the applicator roller 41, with the facing 21 in contact with the roller. The adhesive 26 is picked up from a container 42 positioned beneath the applicator roller 41, with the top surface of the adhesive in the container 42 above the bottom of the applicator roller 41. In preferred embodiments, the roller has relatively wide raised ridges with relatively narrow grooves therebetween. Rotation of the applicator roller 41 automatically picks up adhesive 26. The facing 21 is conveyed (by a set of rollers) to mate with the insulation material 16. The facing 21 is then joined to the insulation 16. A roll 60 is mounted so that it applies sufficient pressure against the facing 21 and the bottom surface of the insulation 16 to result in the facing being securely bonded to the insulation.

Although the laminating station 100 bonds the facing 21 to the bottom surface of the insulation 16, one of ordinary skill will understand that the laminating station may be arranged differently, for example, in an arrangement that bonds the facing 21 to the top surface of the insulation 16.

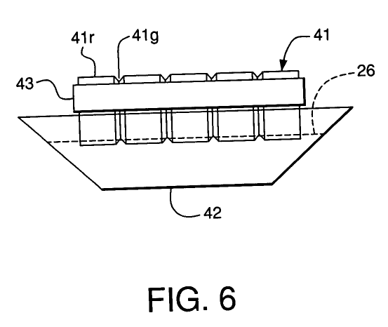

FIG. 6 is a detailed diagram showing the applicator roller 41 of FIG. 5. A grooved roll 41 is used. The grooved roll 41 has flat and relatively wide ridges 41r and relatively narrow grooves 41g that are as wide as or narrower than the ridges. This type of roll 41 is placed in the adhesive reservoir 42, and the metering roll 43 is located nearly in contact with the adhesive roll 41. The adhesive is then picked up by the adhesive roll 41, the ridges 41r are wiped clean by the metering roll 43, and the adhesive within the grooves 41g is transferred to the facing 21, forming a pattern of stripes. For ease of viewing, FIG. 6 only shows four grooves 41g, but any desired number of grooves may be used.

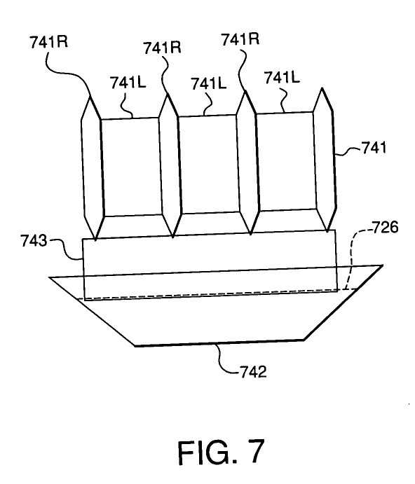

FIG. 7 shows an alternative application apparatus, having relatively narrow ridges 741r separated by relatively wide lands 7411. The adhesive roll 741 shown in FIG. 7 picks up the adhesive 26 on the tips of the ridges 741r. In this example, the roll 741 does not directly contact the adhesive in the reservoir 742. A “metering roll” 743 picks up the adhesive 726 in the reservoir 742. The grooved roll 741 is preferably located above the surface of the adhesive 726 and preferably picks up adhesive 726 by touching the metering roll 743. The “metering roll” 743 picks up the adhesive 726, and transfers the adhesive to the tips of the ridges 741r shown in FIG. 7. For ease of viewing, FIG. 7 only shows four ridges 741r, but any desired number of ridges may be used.

The adhesive 726 is picked up in stripes, and can be deposited on the facing 21 in stripes. In some embodiments, an automatic means (not shown) for maintaining the level of the adhesive 26 in the container 42 is provided. The level maintaining means (not shown) may include a float and a position sensor, coupled to a control valve that admits adhesive when the level falls below a first predetermined threshold level, and stops admitting adhesive when the level rises to a second predetermined threshold level. In other embodiments, the adhesive level may be controlled by feeding a predetermined steady-state input flow rate of adhesive 26 into the container 42. In other embodiments, the adhesive level in container 42 may be controlled manually.

In other embodiments, a gravure roll (not shown) may be used for application of adhesive. The gravure roll can apply distinct dots of material in almost any configuration. In the case of a gravure roll, a wiping blade is used instead of a metering roll.

In still some other embodiments, the adhesive for laminating the facing can be spray applied in an approximately sinusoidal, approximately sawtooth, approximately square wave or other periodic repeating pattern to allow for a plurality of the perforations to remain open for moisture transmission. The adhesive spray can be applied using a nozzle with a relatively small orifice. Alternatively, the adhesive can be applied using a stencil to form the adhesive pattern, in which case a nozzle having a wider stream can be used.

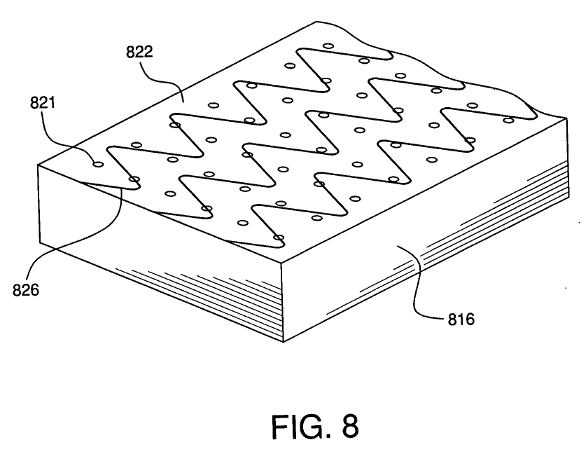

FIG. 8 shows an embodiment including a blanket 816 having a facing 821 in which each of a plurality of substantially sinusoidal patterns 826 of adhesive is woven around the individual holes 822 in a respective row of holes. There is a corresponding pattern 826 for each row of holes 822.

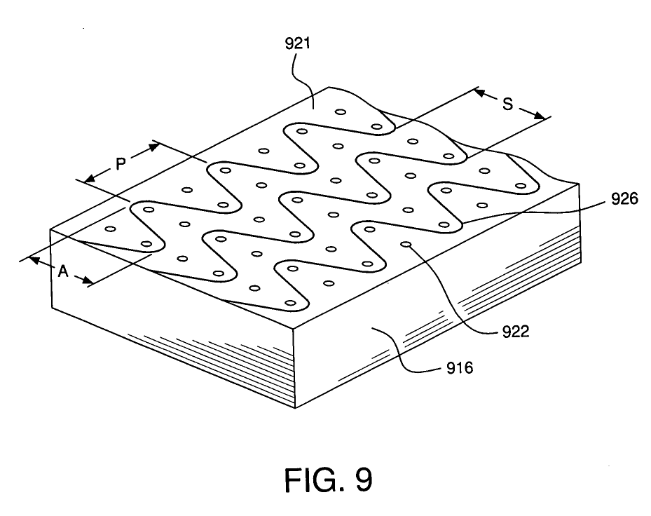

FIG. 9 shows an embodiment of a blanket 916 having a facing 921 in which a plurality of periodic approximately sinusoidal (or approximately sawtooth) patterns 926 have an amplitude A and a spacing S between patterns, either or both of which can be greater than the spacing between rows of holes 922. The period P of each sinusoidal pattern 926 can be greater than the distance between columns of holes. Depending on all of these parameters, and any offset between the patterns 926 and the rows of holes 922, this configuration of patterns 926 may result in few or zero holes 922 being blocked with adhesive.

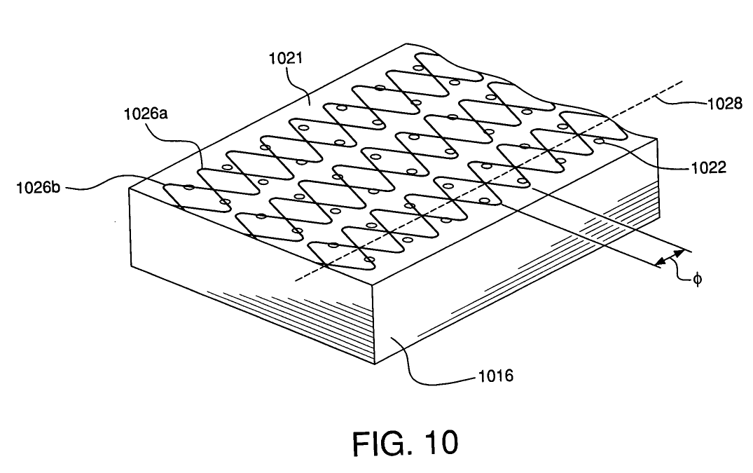

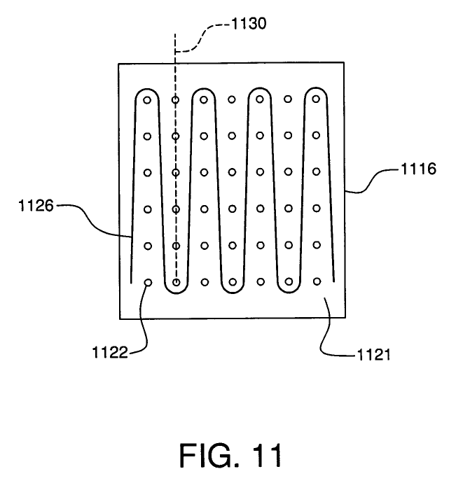

FIG. 10 shows an embodiment of a blanket 1016 having a facing 1021 with a plurality of rows of holes 1022, in which a plurality of periodic approximately sawtooth (or approximately sinusoidal) patterns 1026a, 1026b are provided in groups of two or more. Each group 1026a, 1026b oscillates about the same axis 1028, but there is a phase difference Φ between patterns within the same group. Although only two patterns are shown in each group, the groups may include any desired number of patterns 1026a to 1026n oscillating about the same axis 1028, to increase the density of the adhesive. If more than two patterns are included per group, the phase difference between each successive pair of patterns in the group may be the same as or different from each other. The axis 1028 of one or more of the groups may pass through a row of perforations, or may be offset from a nearest row of perforations.

In other embodiments, as shown in FIG. 11, the period of the substantially sinusoidal pattern is a multiple of the spacing of the rows of perforations. In the blanket 1116 of FIG. 11, the facing 1121 has a pattern of adhesive 1126 with a period that is twice the distance between rows of perforations 1122. The pattern 1126 is elongated, with a respective approximately straight segment in between each successive pair of rows 1122, and a curved connecting portion connecting the ends of each successive pair of approximately straight segments. To avoid having a substantial portion of the substantially sinusoidal pattern 1126 overlying one of the rows 1122 of holes, the adhesive can be applied so that the adhesive only crosses a line segment 1130 connecting one of the rows at a plus or minus peak of the sinusoidal pattern. (That is, the crossings should occur at phase angles of the sinusoidal pattern given by θ=(2n+1)*π/2 radians, where n is any integer. This ensures that no approximately-vertical segment of the sinusoidal pattern 1126 overlies a row of perforations 1122. That is, the approximately vertical segments of the sinusoidal pattern are offset from the rows of perforations. Depending on the thickness of the adhesive pattern, the amplitude (height) of the pattern, and the spacing of the rows of perforations, the sinusoidal pattern may optionally cross the line segment passing through one or more of the rows of perforations without overlapping any of the holes.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A method for joining a perforated facing having periodic rows of perforations to insulation, comprising the steps of:
applying adhesive to the perforated facing in a periodic pattern of stripes; and
joining the facing to the insulation,
wherein a first distance between each pair of adjacent rows of perforations in the facing is different from a second distance between each pair of adjacent stripes of adhesive, so that at least some of the rows of perforations do not coincide with any of the stripes of adhesive.

2. The method of claim 1, wherein the second distance is greater than the first distance.

3. The method of claim 2, wherein a ratio of the second distance to the first distance is an integer.

4. The method of claim 2, wherein a ratio of the second distance to the first distance is not an integer.

5. The method of claim 2, wherein at least one stripe of adhesive is located on or under one of the rows of perforations.

6. The method of claim 1, wherein the applying step includes applying adhesive to the facing with a grooved roller.

7. The method of claim 6, wherein the applying step includes passing the facing over the roller, with the facing in contact with the roller.

8. The method of claim 7, wherein the applying step includes picking up the adhesive from a container beneath the roller.

9. The method of claim 1, wherein:
a second distance between a pair of adjacent stripes of adhesive is a multiple of a first distance between a pair of adjacent rows of perforations in the facing;
at least one stripe of adhesive is located under one of the rows of perforations; and
the applying step includes:
picking up the adhesive with a grooved roller from a container beneath the grooved roller,
passing the facing over the roller, with the facing in contact with the grooved roller, and
applying adhesive to the facing with the grooved roller.

10. A method for joining a facing having a plurality of periodic rows of perforations to insulation, comprising the steps of:
applying adhesive to the perforated facing in a periodic pattern of adhesive; and
joining the facing to the insulation,
wherein the periodic pattern is offset from the rows of perforations, so that substantially all of the perforations do not coincide with any of the pattern of adhesive.

11. The method of claim 10, wherein the applying step includes applying adhesive to the facing with a grooved roller.

12. The method of claim 11, wherein the applying step includes passing the facing over the roller, with the facing in contact with the roller.

13. The method of claim 12, wherein the applying step includes picking up the adhesive from a container beneath the roller.

14. The method of claim 10, wherein the pattern is approximately sinusoidal or sawtoothed.

15. The method of claim 14, wherein a group of two or more patterns oscillate about a common axis with a phase difference therebetween.

16. An insulation product comprising:
a layer of insulation;
a perforated facing having rows of perforations;
a periodic pattern of adhesive joining the perforated facing to the insulation,
wherein the periodic pattern is offset from the rows of perforations, or the period of the pattern is different from the period of the rows of perforations, so that at least some of the rows of perforations do not coincide with any of the stripes of adhesive.

17. The insulation product of claim 16, wherein a second distance between a pair of adjacent stripes of adhesive is different from a first distance between a pair of adjacent rows of perforations in the facing.

18. The insulation product of claim 17, wherein the second distance is greater than the first distance.

19. The insulation product of claim 18, wherein the second distance is a multiple of the first distance.

20. The insulation product of claim 18, wherein stripes of adhesive are located on or under alternating ones of the rows of perforations.

21. The insulation product of claim 16, wherein a second distance between each pair of adjacent stripes of adhesive is substantially the same as a first distance between each pair of adjacent rows of perforations in the facing, and the stripes of adhesive are offset from the rows of perforations.

22. The insulation product of claim 16, wherein the insulation comprises glass or mineral wool, the facing comprises foil-scrim-kraft or polypropylene-scrim-kraft, and the adhesive is a water based adhesive.

23. The insulation product of claim 16, wherein the periodic pattern comprises a plurality of approximately sinusoidal or approximately sawtoothed shapes.
